(19) United States
(12) Patent Application Publication
(10) Pub. No.: US 2012/0307078 A1
(43) Pub. Date: Dec. 6, 2012

(54) AUTOMATIC SHARING AND REPLACEMENT OF CONTENT BASED ON NETWORK CONNECTIVITY

(75) Inventors: Jonathan David Canan, Bellevue, WA (US); Marc McClure, Seattle, WA (US); David Alan Citron, Redmond, WA (US); Navjot Virk, Sammamish, WA (US)

(73) Assignee: Microsoft Corporation, Redmond, WA (US)

(21) Appl. No.: 13/152,266

(22) Filed: Jun. 3, 2011

(51) Int. Cl. H04N 5/225; G06F 15/16

(52) U.S. Cl. 348/207.1; 709/217; 348/E05.024

(57) ABSTRACT

Embodiments enable automatic and immediate sharing of reduced resolution versions of content captured by a user computing device and subsequent replacement of the reduced resolution versions with full resolution versions based on network connectivity. The user computing device captures image data in full resolution. A reduced resolution version is automatically created and uploaded to a storage service. The storage service provides the reduced resolution version to computing devices associated with the user computing device. Subsequently, based on network connectivity characteristics of a network connection between the user computing device and the storage service, the user computing device transmits the full resolution version of the image data to the storage service. The storage service replaces the reduced resolution version stored by the computing devices with the full resolution version. In some embodiments, the reduced resolution version is transmitted over a cellular network and the full resolution version is transmitted over Wi-Fi.

### BACKGROUND

With some existing systems, users can upload photographs taken by a mobile telephone to a cloud service. For example, the user connects a cable from the mobile telephone to a laptop, downloads the photographs from the mobile telephone to the laptop, and then uploads the photographs from the laptop to the cloud service. Once uploaded, the user can log in to the cloud service with any device to view the photographs. Such existing systems require significant user involvement.

In some systems, the mobile telephone can upload the photographs to the cloud service using the mobile telephone's connection. Such systems may consume significant bandwidth, resulting in increased cost, latency, and battery usage, which ultimately degrades the user experience.

### SUMMARY

Embodiments of the disclosure provide bandwidth-aware synchronization of content with registered devices using temporary cloud service storage. A user computing device accesses a first version of image data stored in a memory area. The first version is of a first resolution. The user computing device creates a second version of the accessed image data. The second version is of a second resolution. The second resolution is less than the first resolution. The user computing device transmits the second version of the accessed image data to a storage service. The storage service provides the transmitted second version to one or more computing devices associated with the user computing device. Network connectivity between the user computing device and the storage service is analyzed. Based on the analyzed network connectivity, the user computing device transmits the first version of the accessed image data to the storage service. The storage service replaces the provided second version stored by the one or more computing devices with the transmitted first version.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a user computing device communicating with a cloud service to synchronize full resolution versions of image data and reduced resolution versions of image data.

FIG. 2 is an exemplary flow chart illustrating operation of a user computing device to access image data and conditionally synchronize the image data with other computing devices based on network connectivity characteristics.

FIG. 3 is an exemplary block diagram illustrating a mobile telephone transmitting low resolution images to a storage service.

FIG. 4 is an exemplary block diagram illustrating a mobile telephone transmitting high resolution images to a storage service.

Corresponding reference characters indicate corresponding parts throughout the drawings.

### DETAILED DESCRIPTION

Referring to the figures, embodiments of the disclosure enable bandwidth-conscious synchronization of content using a storage service 302. In some embodiments, low resolution versions 312 of content from a user computing device 102 are automatically uploaded to the storage service 302 for synchronization with other devices. Once the user computing device 102 establishes a faster connection (e.g., Wi-Fi instead of cellular), the user computing device 102 automatically uploads high resolution versions 314 of the content to replace the low resolution versions 312 previously sent. In this manner, data bandwidth costs are minimized while the immediacy of the initial upload is preserved. In some embodiments, while the low resolution versions 312 are maintained for subsequent access after synchronization, the high resolution versions 314 are deleted from the storage service 302 after synchronization to reduce server costs.

Aspects of the disclosure enable user-generated content to be automatically available on any user device. In some embodiments, pictures and videos captured on the user computing device 102 are automatically available in full resolution on registered devices, as well as in reduced resolution on the storage service 302 for access from any network-connected device.

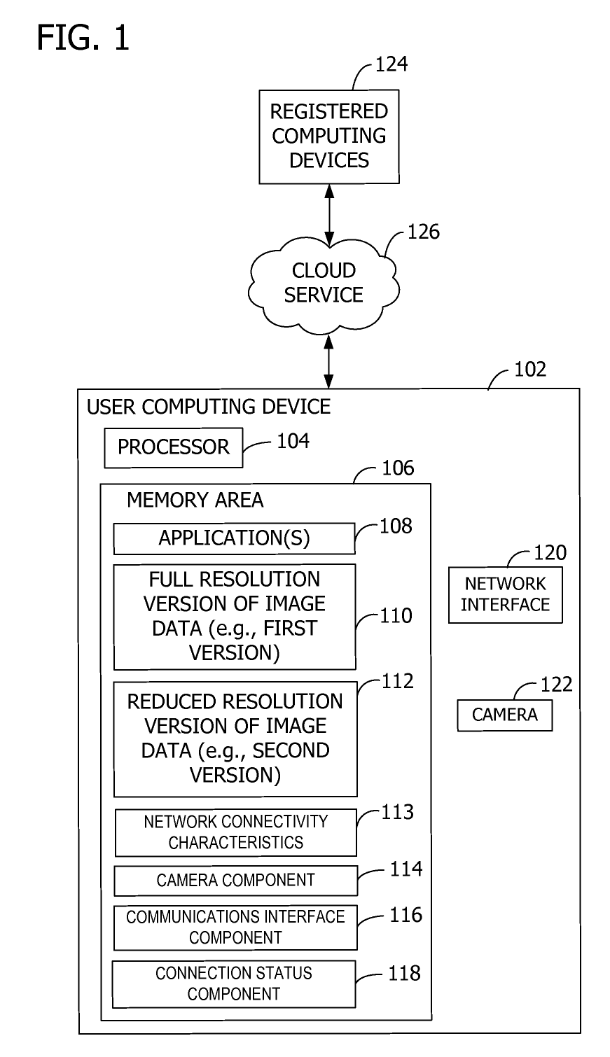

Referring next to FIG. 1, an exemplary block diagram illustrates the user computing device 102 communicating with a cloud service 126 to synchronize full resolution versions 110 of image data and reduced resolution versions 112 of image data with registered computing devices 124. The user computing device 102 and the cloud service 126 represent a system for bandwidth-aware synchronization of photographs and other image data with the registered computing devices 124 using the cloud service 126 as temporary storage. In the example of FIG. 1, the user computing device 102 is associated with a user. The user computing device 102 represents any device executing instructions (e.g., as application programs, operating system functionality, or both) to implement the operations and functionality associated with the user computing device 102. The user computing device 102 may include a mobile computing device or any other portable device. In some embodiments, the mobile computing device includes a mobile telephone 304, laptop 310, tablet 306, computing pad, netbook, gaming device, and/or portable media player 308. The user computing device 102 may also include less portable devices such as desktop personal computers, kiosks, and tabletop devices. Additionally, the user computing device 102 may represent a group of processing units or other computing devices.

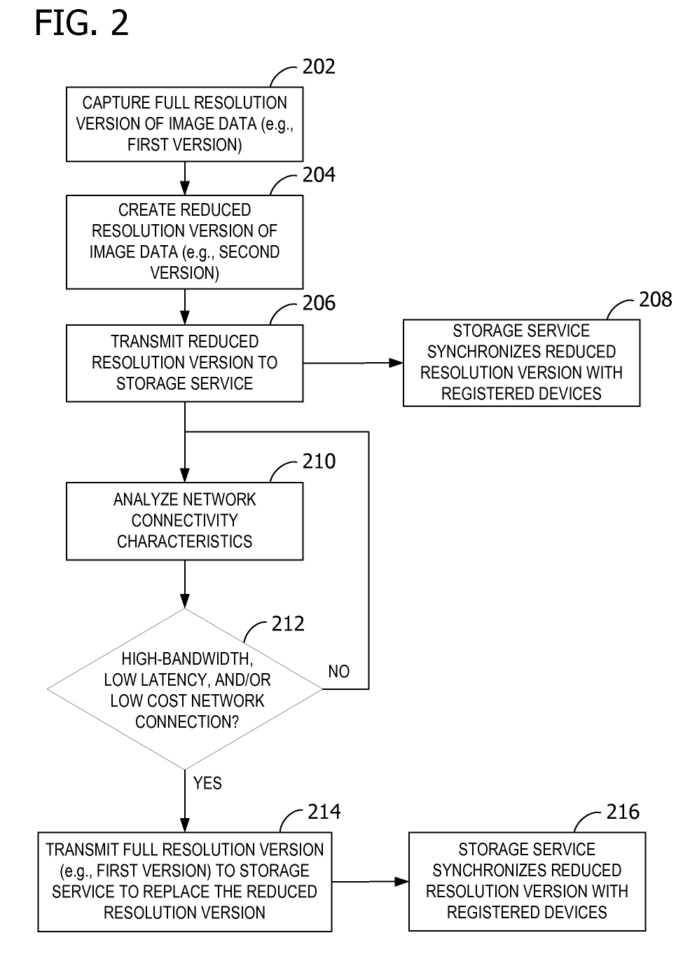

The user computing device 102 has at least one processor 104, a camera 122, at least one network interface 120, and a memory area 106. The processor 104 includes any quantity of processing units, and is programmed to execute computer-executable instructions for implementing aspects of the disclosure. The instructions may be performed by the processor 104 or by multiple processors executing within the user computing device 102, or performed by a processor external to the user computing device 102. In some embodiments, the processor 104 is programmed to execute instructions such as those illustrated in the figures (e.g., FIG. 2).

The camera 122 may be internal (e.g., a built-in camera to the mobile telephone 304) and/or external (e.g., a webcam or other externally-connected photographic imaging device). The camera 122 operates to capture image data and store the captured image data in the memory area 106.

The network interface 120 includes any interface for enabling and/or facilitating communication between the user computing device 102 and the cloud service 126. In some embodiments, the network interface 120 includes a network interface card and/or computer-executable instructions (e.g., a driver) for operating the network interface card.

The user computing device 102 further has one or more computer readable media such as the memory area 106. The memory area 106 includes any quantity of media associated with or accessible by the user computing device 102. The memory area 106 may be internal to the user computing device 102 (as shown in FIG. 1), external to the user computing device 102 (not shown), or both (not shown). For example, the memory area 106 may be a thumb drive or other memory device accessible via a connection such as a universal serial bus (USB), a BLUETOOTH brand connection, and memory card.

The memory area 106 stores, among other data, one or more applications 108. The applications 108, when executed by the processor 104, operate to perform functionality on the user computing device 102. Exemplary applications 108 include mail application programs, web browsers, calendar application programs, address book application programs, messaging programs, media applications, location-based services, search programs, and the like. The applications 108 may communicate with counterpart applications or services such as web services accessible via a network. For example, the applications 108 may represent downloaded client-side applications that correspond to server-side services executing in a cloud.

In some embodiments, the media applications execute to capture image data such as photographic image data. While aspects of the disclosure are operable with static photographs as the image data, other embodiments of the disclosure contemplate the capture of motion video, audio, and/or other media or content.

The memory area 106 further stores full resolution versions 110 of the image data. The full resolution versions 110 may represent raw or uncompressed image data. The memory area 106 further stores reduced resolution versions 112 of the image data. The reduced resolution versions 112 represent copies of the corresponding full resolution versions 110 that have been reduced in resolution, compressed, or otherwise reduced to consume less bandwidth or fewer storage or transmission units.

The memory area 106 further stores network connectivity characteristics 113. The network connectivity characteristics 113 represent factors or units of measure describing a status of connection between the user computing device 102 and the cloud service 126. In some embodiments, the network connectivity characteristics 113 include one or more of the following: bandwidth, congestion, latency, and cost.

The memory area 106 further stores one or more computer-executable components. Exemplary components include a camera component 114, a communications interface component 116, and a connection status component 118.

Operation of the components, when executed, is described below with reference to FIG. 2.

Referring next to FIG. 2, an exemplary flow chart illustrates operation of the user computing device 102 to access image data and conditionally synchronize the accessed image data with other computing devices 124 based on network connectivity characteristics 113. In some embodiments, the image data includes a single photograph or other image, while in other embodiments, the image data includes a plurality of photographs or other images.

The user computing device 102 accesses a first version of image data stored in a memory area such as memory area 106. The first version is of a first resolution. For example, the user computing device 102 captures the full resolution version 110 of the image data at 202. Responsive to the capture, the user computing device 102 creates a second version of the accessed image data. The second version is of a second resolution, where the second resolution is less than the first resolution. For example, the user computing device 102 creates the reduced resolution version 112 of the image data at 204. In general, the second version consumes less bandwidth than the first version.

The user computing device 102 transmits the second version of the accessed image data to the storage service 302 such as the cloud service 126. For example, the user computing device 102 transmits the reduced resolution version 112 of the image data to the storage service 302 at 206. The storage service 302 provides the transmitted second version to one or more computing devices 124 associated with the user computing device 102. For example, the storage service 302 synchronizes the reduced resolution version 112 with the registered computing devices 124 at 208.

In some embodiments, the user computing device 102 sends the reduced resolution version 112 as soon as possible after the capture of the image data and the creation of the reduced resolution version 112 to enable rapid, immediate synchronization and/or storage of the captured image data. During the transmission of the reduced resolution version 112 to the storage service 302, the connection between the user computing device 102 and the storage service 302 may be slow and/or expensive (e.g., a slow cellular connection). As such, anytime after uploading the reduced resolution version 112 to the storage service 302, the user computing device 102 analyzes the network connectivity between the user computing device 102 and the storage service 302 at 210 for an opportunity to transmit the full resolution version 110. In some embodiments, the user computing device 102 attempts to determine if the connection between the user computing device 102 and the storage service 302 is high bandwidth, low congestion, low latency, and/or low cost at 212. For example, the user computing device 102 determines if the connection is a Wi-Fi connection or other fast connection.

Based on the analyzed network connectivity, the user computing device 102 transmits the first version of the image data to the storage service 302. For example, the user computing device 102 may determine that the connection between the user computing device 102 and the storage service 302 has improved sufficiently. In that case, the user computing device 102 transmits the full resolution version 110 to the storage service 302 at 214. If the user computing device 102 determines that the network connectivity has not changed sufficiently to warrant transmission of the full resolution image, the user computing device 102 postpones transmission of the full resolution image until the network connectivity improves. The full resolution image remains in a queue or other storage area associated with the user computing device 102 until the network connectivity improves.

Upon receipt of the first version (e.g., the full resolution version 110) from the user computing device 102, the storage service 302 replaces the second version (e.g., the reduced resolution version 112) stored by the registered computing devices 124 with the first version (e.g., the full resolution version 110) at 216.

The registered computing devices 124 represent devices that the user has identified to receive the image data captured by the user computing device 102. In some embodiments, the user registers each of the computing devices 124 by visiting a web site or by interacting with an operating system or application executing on the user computing device 102. In such an embodiment, the user computing device 102 receives a request to register one of the computing devices 124 from the user. In response, the user computing device 102 adds the requested computing device 124 to a set of devices registered to synchronize image data with the user computing device 102.

In some embodiments, the user computing device 102 accesses or captures metadata associated with the image data. For example, the user computing device 102 may access social activity metadata such as comments, photo tags, ratings, captions, or other metadata describing the image data as known in the art. The metadata may describe where a photograph was taken (e.g., via geotags), identify a mobile telephone hardware model and/or operating system version executing on the mobile telephone 304, and/or identify an application executing on the mobile telephone 304 that was used to capture the image data. In such embodiments, the user computing device 102 provides the metadata along with the image data when communicating with the storage service 302, and the storage service 302 synchronizes the metadata along with the image data when communicating with the registered computing devices 124.

Operations 208 and 216 in FIG. 2 are performed by the storage service 302 without direct communication between the user computing device 102 and the registered computing devices 124, in some embodiments. Further, operations 206, 210, 212, and 214 may be performed by the user computing device 102 automatically without receiving a command from the user to do so. For example, the operations are performed in the background. The user may access settings of the user computing device 102 to authorize the performance of operations 206, 210, 212, and 214 for all image data captured by the user computing device 102. Further, in some embodiments, the user may be notified that one or more full resolution versions 110 have been successfully synchronized.

The operations illustrated in FIG. 2 may be implemented by the computer-executable components illustrated in FIG. 1. The camera component 114, when executed by the processor 104, causes the processor 104 to obtain the first version of the image data. The image data may be stored, if only temporarily, in the memory area 106. The camera component 114 creates the second version of the obtained image data. The communications interface component 116, when executed by the processor 104, causes the processor 104 to transmit the second version of the obtained image data to the storage service 302 responsive to creation of the second version by the camera component 114. The storage service 302 provides the transmitted second version to the registered computing devices 124, or other computing devices associated with the user computing device 102.

The connection status component 118, when executed by the processor 104, causes the processor 104 to analyze the network connectivity of a network connection between the user computing device 102 and the storage service 302. For example, the connection status component 118 may analyze the network connectivity to determine whether the network connectivity satisfies threshold criteria. Exemplary threshold criteria include a pre-defined bandwidth, a pre-defined congestion level, a pre-defined latency value, and/or a pre-defined cost associated with network transmission. The communications interface component 116 compares the analyzed network connectivity to the threshold criteria and transmits the first version to the storage service 302 if the analyzed network connectivity satisfies the threshold criteria. If the network connectivity fails to satisfy the threshold criteria, the communications interface component 116 postpones transmission of the first version to the storage service 302.

The communications interface component 116 transmits, based on the network connectivity analyzed by the connection status component 118, the first version of the accessed image data to the storage service 302. The storage service 302 replaces the provided second version stored by the registered computing devices 124 with the transmitted first version. For example, the storage service 302 may push the first version to each of the registered computing devices 124, or the storage service 302 may notify each of the registered computing devices 124 of the availability of the first version.

In some embodiments, the user may edit one of the full resolution versions 110 or other version of the image data using one of the registered computing devices 124. For example, the user may crop or resize a photograph using laptop 310. Functionality associated with the laptop 310 provides the edited version of the photograph to the storage service 302. The storage service 302 synchronizes the edited version with the user computing device 102, and the user computing device 102 replaces the full resolution version 110 stored by the user computing device 102 with the edited version. In this manner, bi-directional synchronization of the image data is achieved. In some aspects, a high resolution version or a low resolution version of the edited version may be synchronized initially, based on the connection between the laptop 310 and the storage service 302. For example, if the connection is cellular, the low resolution version may be synchronized, and then the replacement high resolution version is synchronized later when the connection becomes a Wi-Fi connection.

In some embodiments (not shown), after operation 202, the user computing device 102 proceeds to operations 214 and 216 if the user computing device 102 has a high-bandwidth, low latency, and/or low cost network connection (e.g., connected via Wi-Fi). In such embodiments, the low resolution version 312 is not created or synchronized.

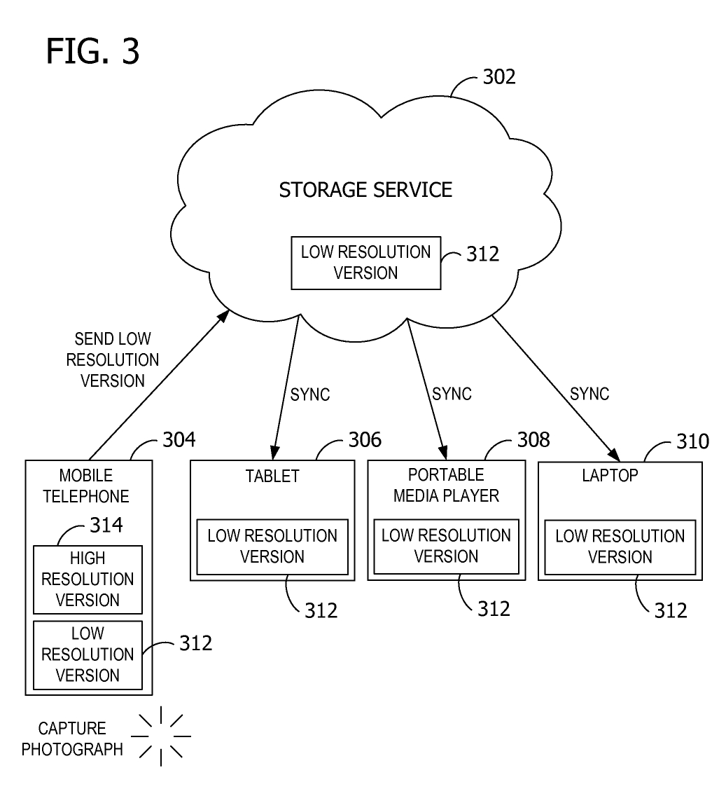

Referring next to FIG. 3, an exemplary block diagram illustrates the mobile telephone 304 transmitting low resolution images to the storage service 302. In the example of FIG. 3, the mobile telephone 304 captures and stores the high resolution version 314 of a photograph. The mobile telephone 304 immediately, or promptly thereafter, creates the low resolution version 312 of the photograph for transmission to the storage service 302. The storage service 302, upon receipt of the low resolution version 312, synchronizes the low resolution version 312 with a tablet 306, portable media player 308, and laptop 310 associated with the mobile telephone 304.

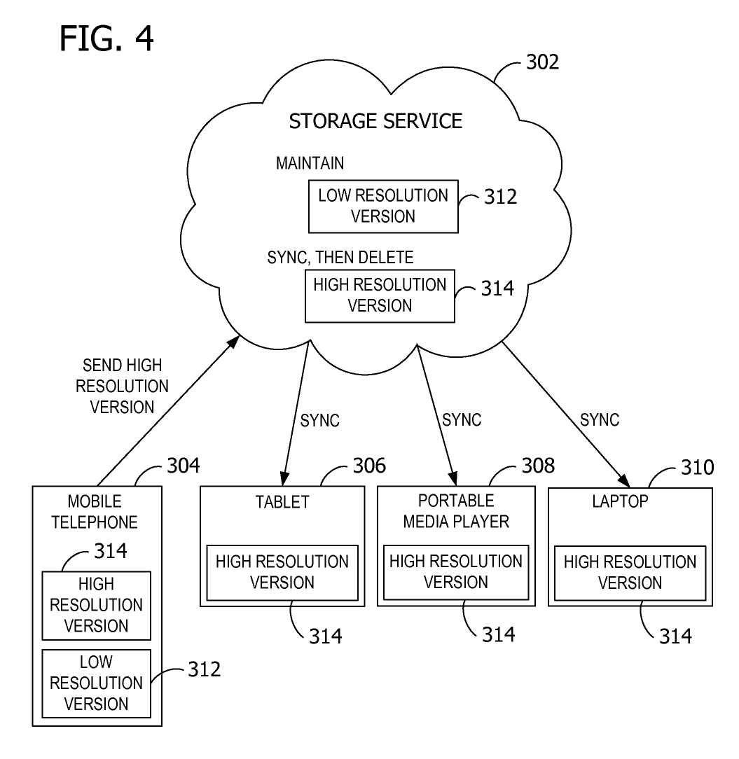

Referring next to FIG. 4, an exemplary block diagram illustrates the mobile telephone 304 transmitting high resolution images to the storage service 302. In the example of FIG. 4, the mobile telephone 304 has determined that the connection between the mobile telephone 304 and the storage service 302 has improved, or satisfies threshold criteria, to warrant transmission of the high resolution version 314. For example, the mobile telephone 304 may now be connected via Wi-Fi to the Internet. The mobile telephone 304 transmits the high resolution version 314 to the storage service 302. The storage service 302, upon receipt of the high resolution version 314, synchronizes the high resolution version 314 with the tablet 306, portable media player 308, and laptop 310 associated with the mobile telephone 304. The tablet 306, portable media player 308, and laptop 310 replaced the previously received low resolution version 312 with the high resolution version 314.

In some embodiments, the storage service 302 deletes the high resolution version 314 from the storage service 302 after synchronization to reduce the memory burden on the storage service 302. The storage service 302 may maintain, however, the low resolution version 312 for subsequent access by the mobile telephone 304, the registered computing devices 124, and/or other devices.

In the example of FIG. 3 and FIG. 4, the mobile telephone 304 maintains or caches the low resolution version 312 and the high resolution version 314. In other embodiments, the mobile telephone 304 may delete the high resolution version 314 after transmitting the high resolution version 314 to the storage service 302 to reduce the memory consumption on the mobile telephone 304. In still other embodiments, the mobile telephone 304 may delete the low resolution version 312 while maintaining the high resolution version 314. For example, the high resolution version 314 may be stored on one or more of the registered computing device 124, while the low resolution version 312 is stored by the storage service 302 to reduce server storage costs.

### Additional Examples

In one exemplary scenario, the user attends a birthday party and takes many pictures using the mobile telephone 304. The user has authorized automatic sharing of the pictures with the storage service 302. As the user takes the pictures, low resolution versions 312 of the pictures are uploaded to the storage service 302 and synchronized with the user's laptop 310. Later that day, the user returns home and the mobile telephone 304 uses a home Wi-Fi connection to upload the full resolution versions 110 of the pictures. Later that night, the user visits a friend and wants to show the pictures from the birthday party. Rather than show the pictures with the small screen on the mobile telephone 304, the user uses the laptop 310 to show the friend the high resolution pictures that, to the user, have automatically appeared on the laptop 310.

At least a portion of the functionality of the various elements in FIG. 1 may be performed by other elements in FIG. 1, or an entity (e.g., processor, web service, server, application program, computing device, etc.) not shown in FIG. 1.

In some embodiments, the operations illustrated in FIG. 2 may be implemented as software instructions encoded on a computer readable medium, in hardware programmed or designed to perform the operations, or both. For example, aspects of the disclosure may be implemented as a system on a chip.

While no personally identifiable information is tracked by aspects of the disclosure, embodiments have been described with reference to data monitored and/or collected from users. In such embodiments, notice is provided to the users of the collection of the data (e.g., via a dialog box or preference setting) and users are given the opportunity to give or deny consent for the monitoring and/or collection. The consent may take the form of opt-in consent or opt-out consent.

For example, the user may opt-in to sharing captured photographs with the storage service 302.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media store information such as computer readable instructions, data structures, program modules or other data. Computer storage media exclude propagated data signals. Communication media typically embody computer readable instructions, data structures, program modules, or other data in a modulated data signal such as a carrier wave or other transport mechanism and include any information delivery media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for immediate synchronization of the reduced resolution version 112 of the photographic image data with the registered computing devices 124 followed by conditional synchronization of the full resolution version 110 of the photographic image data dependent on network connectivity, and exemplary means for bandwidth-aware bi-directional synchronization of the photographic image data with the registered computing devices 124.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for bandwidth-aware synchronization of photographs with registered devices using temporary cloud service storage, said system comprising:
a memory area associated with a mobile computing device, said memory area storing a full resolution version of photographic image data and a reduced resolution version of the photographic image data;
a camera associated with the mobile computing device;
a network interface; and
a processor programmed to:
capture, by the camera, the full resolution version of the photographic image data;
responsive to the capture, create the reduced resolution version of the captured photographic image data;
responsive to creation of the reduced resolution version, automatically transmit the reduced resolution version of the captured photographic image data to a storage service, the storage service synchronizing the transmitted reduced resolution version with one or more computing devices registered with the storage service and associated with the mobile computing device;
analyze network connectivity between the user computing device and the storage service; and
based on the analyzed network connectivity, transmit the full resolution version of the captured photographic image data to the storage service, the storage service synchronizing the full resolution version with the computing devices to replace the reduced resolution version stored thereon.

2. The system of claim 1, wherein the processor is programmed to automatically transmit the reduced resolution version by transmitting the reduced resolution version without receiving a command from a user of the mobile computing device.

3. The system of claim 1, wherein the reduced resolution version consumes less bandwidth during transmittal than the full resolution version.

4. The system of claim 1, wherein the storage service maintains the reduced resolution version for subsequent access by the mobile computing and/or the registered computing devices.

5. The system of claim 1, further comprising means for immediate synchronization of the reduced resolution version of the photographic image data with the registered computing devices followed by conditional synchronization of the full resolution version of the photographic image data dependent on the analyzed network connectivity.

6. The system of claim 1, further comprising means for bandwidth-aware bi-directional synchronization of the photographic image data with the registered computing devices.

7. A method comprising:
accessing, by a user computing device, a first version of image data stored in a memory area, said first version being of a first resolution;
creating, by the user computing device, a second version of the accessed image data, said second version being of a second resolution, said second resolution being less than said first resolution;
transmitting, by the user computing device, the second version of the accessed image data to a storage service, the storage service providing the transmitted second version to one or more computing devices associated with the user computing device;
analyzing network connectivity between the user computing device and the storage service; and
based on the analyzed network connectivity, transmitting, by the user computing device, the first version of the accessed image data to the storage service, the storage service replacing the provided second version stored by said one or more computing devices with the transmitted first version.

8. The method of claim 7, wherein said analyzing occurs subsequent to said transmitting.

9. The method of claim 7, wherein creating the second version comprises creating a version that consumes less bandwidth than the first version during transmittal.

10. The method of claim 7, further comprising:
receiving a request from a user of the user computing device to register a device;
registering the device with the storage service, wherein the storage service includes the device in said one or more computing devices.

11. The method of claim 7, wherein analyzing the network connectivity comprises analyzing one or more of the following: bandwidth, congestion, latency, and cost.

12. The method of claim 7, wherein the user computing device deletes the first version as stored by the user computing device after transmitting the first version.

13. The method of claim 7, wherein the user computing device maintains the first version in a cache after transmitting the first version.

14. The method of claim 7, wherein accessing the first version comprises accessing social activity metadata associated with the first version, said social activity metadata comprises one or more of the following: comments, photo tags, ratings, and captions.

15. The method of claim 14, wherein the storage service further synchronizes the social activity metadata with said one or more computing devices.

16. The method of claim 7, wherein the storage service provides the transmitted second version and replaces the provided second version without the user computing device communicating with said one or more computing devices.

17. One or more computer storage media embodying computer-executable components, said components comprising:
a camera component that when executed causes at least one processor to obtain a first version of image data stored in a memory area associated with a user computing device, said first version being of a first resolution, said camera component further creating a second version of the obtained image data, said second version being of a second resolution, said second resolution being less than said first resolution;
a communications interface component that when executed causes at least one processor to transmit the second version of the obtained image data to a storage service responsive to creation of the second version by the camera component, the storage service providing the transmitted second version to one or more computing devices associated with the user computing device; and
a connection status component that when executed causes at least one processor to analyze network connectivity of a network connection between the user computing device and the storage service,
wherein the communications interface component transmits, based on the network connectivity analyzed by the connection status component, the first version of the obtained image data to the storage service, the storage service replacing the provided second version stored by said one or more computing devices with the transmitted first version,
wherein the communications interface component receives from the storage service an edited version of the transmitted first version, said edited version being created by one of said one or more computing devices, wherein the user computing device replaces the first version with the edited version.

18. The computer storage media of claim 17, wherein the connection status component analyzes the network connectivity to determine whether the network connectivity satisfy threshold criteria.

19. The computer storage media of claim 18, wherein the communications interface component transmits the first version to the storage service if the network connectivity satisfies the threshold criteria.

20. The computer storage media of claim 18, wherein the communications interface component postpones transmission of the first version to the storage service if the network connectivity fails to satisfy the threshold criteria.
